(19) United States
(12) Patent Application Publication
(10) Pub. No.: US 2015/0381863 A1
(43) Pub. Date: Dec. 31, 2015

(54) Optical System and Imaging Device

(71) Applicant: Tamron Co., Ltd., Saitama-shi (JP)

(72) Inventors: Keisuke Okada, Saitama-shi (JP); Shingo Abe, Saitama-shi (JP)

(21) Appl. No.: 14/751,344

(22) Filed: Jun. 26, 2015

(30) Foreign Application Priority Data
Jun. 30, 2014 (JP) 2014-134561

(51) Int. Cl. H04N 5/225; G02B 27/64

(52) U.S. Cl. CPC H04N 5/2254; G02B 27/646

(57) ABSTRACT

An optical system including: a first lens group Gf; a vibration control lens group Gvc; and a third lens group Gr, the first lens group Gf, the vibration control lens group Gvc, and the third lens group Gr being provided in order from an object side. The third lens group Gr has at least one lens having negative refractive power, and specified conditional expressions are satisfied.

### CROSS-REFERENCE TO RELATED APPLICATION

This application claims priority to Japanese Patent Application No. 2014-134561 filed Jun. 30, 2014, the disclosure of which is hereby incorporated in its entirety by reference.

### BACKGROUND OF THE INVENTION

1. Field of the Invention

The present invention relates to an optical system suitable as an imaging optical system and an imaging device. The present invention more particularly relates to an optical system and an imaging device having a vibration control function for reducing image blurring attributed to vibration such as camera shake during imaging.

2. Description of the Related Art

Imaging devices including a solid-state image sensor, such as digital cameras and video cameras, have long been prevailing. In recent years, as the optical system in an interchangeable lens system is miniaturized, the market of interchangeable lens type imaging devices, such as single-lens reflex cameras and mirrorless single lens cameras, is considerably expanding. As a result, larger user groups are now using the interchangeable lens type imaging device. Such expansion of the user groups leads to a demand for the optical system in the interchangeable lens system not only with higher performance and smaller size but also with higher brightness and a larger aperture. There also rises a strong demand for reduction of image blurring attributed to vibration such as camera shake during imaging. Cost reduction is also demanded together with these demands.

Under such circumstances, an inner-focus telephoto lens of large aperture is disclosed in Japanese Patent No. 4639635, for example. The lens maintains optical performance while an overall length thereof is made shorter. The optical system of the lens includes a vibration control optical system to sufficiently correct image blurring attributed to vibration such as camera shake at the time of imaging.

### SUMMARY OF THE INVENTION

While the optical system disclosed in Japanese Patent No. 4639635 demonstrates sufficient optical performance, the vibration control optical system is constituted of a positive lens group including three lenses. Further miniaturization and weight reduction of the vibration control optical system is, therefore, demanded.

Accordingly, an object of the present invention is to achieve miniaturization and weight reduction of a vibration control optical system, and to provide an optical system which is excellent in optical performance during vibration control and which has high brightness and a large aperture.

Inventors of the present invention have come to accomplish the above object by adopting the following optical system as a result of intensive researches.

An optical system according to the present invention includes: a first lens group Gf; a vibration control lens group Gvc for changing an image position by moving in a direction perpendicular to an optical axis; and a third lens group Gr, the first lens group Gf, the vibration control lens group Gvc, and the third lens group Gr being provided in order from an object side, wherein the third lens group Gr includes at least one lens having negative refractive power, and following conditional expressions (1) to (3) are satisfied:

−0.60<(1−βvc)βr<−0.32 (1)

0.60<|fr|/f<3.90 (2)

−0.3<Cr1vc/ff<9.0 (3)

wherein βvc is a magnification of the vibration control lens group Gvc, βr is a magnification of the third lens group Gr, f is a focal length of the whole optical system, fr is a focal length of the third lens group Gr, Cr1vc is a curvature radius of a surface closest to the object side in the vibration control lens group Gvc, and ff is a focal length of the first lens group Gf.

In the optical system according to the present invention, F-number of the whole system is preferably brighter than 2.8.

In the optical system according to the present invention, the third lens group Gr preferably has positive refractive power.

In the optical system according to the present invention, the vibration control group Gvc preferably satisfies a following conditional expression (4).

−10.0<fvc/f<−0.1 (4)

wherein fvc is a focal length of the vibration control lens group Gvc.

In the optical system according to the present invention, the first lens group Gf preferably satisfies a conditional expression (5):

0.50<|ff/f| (5)

An imaging device according to the present invention includes: the above optical system; and an image sensor provided on an image side of the optical system for converting an optical image formed by the optical system into an electrical signal.

According to the present invention, it becomes possible to achieve miniaturization and weight reduction of a vibration control optical system, and to provide an optical system having excellent optical performance during vibration control, high brightness and a large aperture.

### BRIEF DESCRIPTION OF THE DRAWINGS

FIG. 1 is a cross sectional view illustrating a configuration example of lenses in an optical system (fixed-focus lens) in Example 1 of the present invention;

FIG. 2 illustrates diagrams of spherical aberration, astigmatism, and distortion aberration when the optical system in Example 1 focuses at infinity;

FIG. 3A illustrates lateral aberration diagrams when the optical system in Example 1 is in a reference state when focusing at infinity, and FIG. 3B illustrates lateral aberration diagrams when the optical system corrects an angular shake of 0.3 degrees when focusing at infinity;

FIG. 4 is a cross sectional view illustrating a configuration example of lenses in an optical system (fixed-focus lens) in Example 2 of the present invention;

FIG. 5 illustrates diagrams of spherical aberration, astigmatism, and distortion aberration when the optical system in Example 2 focuses at infinity;

FIG. 6A illustrates lateral aberration diagrams when the optical system in Example 2 is in a reference state when focusing at infinity, and FIG. 6B illustrates lateral aberration diagrams when the optical system corrects an angular shake of 0.3 degrees when focusing at infinity;

FIG. 7 is a cross sectional view illustrating a configuration example of lenses in an optical system (fixed-focus lens) in Example 3 of the present invention;

FIG. 8 illustrates diagrams of spherical aberration, astigmatism, and distortion aberration when the optical system in Example 3 focuses at infinity;

FIG. 9A illustrates lateral aberration diagrams when the optical system in Example 3 is in a reference state when focusing at infinity, and FIG. 9B illustrates lateral aberration diagrams when the optical system corrects an angular shake of 0.3 degrees when focusing at infinity;

FIG. 10 is a cross sectional view illustrating a configuration example of lenses in an optical system (fixed-focus lens) in Example 4 of the present invention;

FIG. 11 illustrates diagrams of spherical aberration, astigmatism, and distortion aberration when the optical system in Example 4 focuses at infinity;

FIG. 12A illustrates lateral aberration diagrams when the optical system in Example 4 is in a reference state when focusing at infinity, and FIG. 12B illustrates lateral aberration diagrams when the optical system corrects an angular shake of 0.3 degrees when focusing at infinity;

FIG. 13 is a cross sectional view illustrating a configuration example of lenses in an optical system (fixed-focus lens) in Example 5 of the present invention;

FIG. 14 illustrates diagrams of spherical aberration, astigmatism, and distortion aberration when the optical system in Example 5 focuses at infinity; and

FIG. 15A illustrates lateral aberration diagrams when the optical system in Example 5 is in a reference state when focusing at infinity, and FIG. 15B illustrates lateral aberration diagrams when the optical system corrects an angular shake of 0.3 degrees when focusing at infinity.

### DETAILED DESCRIPTION OF THE PREFERRED EMBODIMENTS

Hereinafter, embodiments of an optical system and an imaging device according to the present invention will be described.

### 1-1. Configuration of Optical System

First, the configuration of the optical system according to the present invention will be described. The optical system according to the present invention includes a first lens group Gf, a vibration control lens group Gvc for changing an image position by moving in a direction perpendicular to an optical axis; and a third lens group Gr, provided in order from an object side. The third lens group Gr has at least one lens having negative refractive power, and later-described conditional expressions (1) to (3) are satisfied. It is preferable to satisfy conditional expressions (4) to (7). According to the present invention, it becomes possible to achieve miniaturization and weight reduction of the vibration control optical system, and to provide an optical system (hereinafter referred to as “a lens of large aperture”) which has excellent optical performance (image formation performance) even during vibration control, high brightness and a large aperture. Hereinafter, the configuration and the conditional expressions of the optical system will be described in order.

### (1) First Lens Group Gf

As long as the first lens group Gf in the optical system is configured so as to satisfy at least the conditional expressions (1) to (3), the refractive power of the first lens group Gf may be positive or may be negative, and the specific lens configuration thereof is not particularly limited.

### (2) Vibration Control Lens Group Gvc

As long as the vibration control lens group Gvc is configured to satisfy at least the conditional expressions (1) to (3), the refractive power and the specific lens configuration of the vibration control lens group Gvc are not particularly limited. According to the present invention, the vibration control lens group Gvc is placed between the first lens group Gf and the third lens group Gr, and at least the conditional expressions (1) to (3) are satisfied. As a result, it becomes possible to achieve miniaturization and weight reduction of the vibration control lens group Gvc, and to provide a lens of large aperture which is excellent in optical performance during vibration control and which has high brightness and a large aperture.

The refractive power of the vibration control lens group Gvc may be positive or may be negative. However, from the viewpoint of achieving weight reduction of the vibration control lens group Gvc, the vibration control lens group Gvc preferably has negative refractive power. In order to implement a lens of high brightness and large aperture, it is required to constitute the optical system from a lens of a large external diameter so as to taken in more light. Accordingly, when the vibration control lens group Gvc is made to have negative refractive power, it becomes easy to reduce the thickness of the lenses which constitute the vibration control lens group Gvc. As a result, weight reduction of the vibration control lens group Gvc can be achieved. In connection with this, loads of an actuator, a drive motor and the like that drive the vibration control lens group Gvc can be decreased, which makes it possible to miniaturize these vibration-control drive mechanisms. As a result, a lens-barrel for housing the optical system, the vibration-control drive mechanisms, and the like may have a smaller external diameter.

While the vibration control lens group Gvc may be constituted of a plurality of lens units, the vibration control lens group Gvc is preferably constituted of a single lens unit having negative refractive power from the viewpoint of reducing the weight of the vibration control lens group Gvc and reducing the length (hereinafter, referred to as overall lens length) of the optical system in an optical axis direction. When the vibration control lens group Gvc is constituted of a single lens unit having negative refractive power, the weight of the vibration control lens group Gvc can be reduced and the optical system can be miniaturized as compared with the case where the vibration control lens group Gvc is constituted of a plurality of lens units.

Furthermore, the vibration control lens group Gvc may be constituted of a single lens unit formed by integrating a plurality of lenses, such as a cemented lens. However, from the viewpoint of reducing the weight of the vibration control lens group Gvc and reducing the length of the optical system in the optical axis direction, the vibration control lens group Gvc is preferably constituted of a single lens having negative refractive power. When the vibration control lens group Gvc is constituted of a single lens having negative refractive power, the weight of the vibration control lens group Gvc can be reduced and the optical system can be miniaturized as compared with the case where the vibration control lens group Gvc is constituted of a plurality of lens.

The lens unit herein refers to, in addition to a single lens, a cemented lens made up of a plurality of lenses, such as positive lens and negative lens, whose optical surfaces are bonded or tightly attached to each other without an air layer interposed therebetween and the like. A lens unit made up of a plurality of lenses integrated with an air layer interposed between the optical surfaces of the lenses are excluded from the lens unit.

The single lens refers to one lens (optical element) having two optical surfaces: one on an object side; and the other on an image side. The single lens includes those having various coatings applied to their optical surfaces, such as antireflection coatings and protective coatings. The shape or the like of the optical surface of the single lens is not particularly limited. The single lens may be a spherical lens or may be an aspheric lens. The single lens may include a so-called compound aspheric lens wherein a thin resin layer is formed on a surface of a spherical lens to constitute an aspherical surface, and may include a lens having one surface being flat. The method for manufacturing the single lens is not particularly limited, and various single lenses may be manufactured by such methods as polishing, mold molding, or injection molding. The single lens may be a glass lens made of a glass material or may be a resin lens and the like made of a resin material. The material and the like of the single lens is not particularly limited.

Furthermore, from the viewpoint of reducing the weight of the vibration control lens group Gvc and reducing the overall lens length of the vibration control lens group Gvc, the vibration control lens group Gvc is more preferably constituted of a single lens unit. The single lens unit herein refers to a lens unit, such as the above-stated single lens and the compound lens, which has two optical surfaces within the unit. The lens units, such as cemented lenses, which have three or more optical surfaces within the units are excluded from the single lens unit.

### (3) Third Lens Group Gr

The refractive power and the specific lens configuration of the third lens group Gr are not limited as long as the third lens group Gr includes at least one lens having negative refractive power and is configured to satisfy at least the conditional expressions (1) to (3) as described before. When at least one lens having negative refractive power is placed in the third lens group Gr, chromatic aberration generated within the optical system can be reduced in the third lens group Gr. While the refractive power of the third lens group Gr may be positive or may be negative, the third lens group Gr preferably has positive refractive power from the viewpoint of miniaturizing the lens of large aperture. When the third lens group Gr, which is the final group in the optical system, is made to have positive refractive power, the final group is provided with a converging function and a lower magnification, so that the first lens group Gf placed on the object side may have a decreased diameter.

### 1-2. Conditional Expressions

A description is now given of the conditional expressions. As described in the foregoing, the optical system satisfies the following conditional expressions (1) to (3). Hereinafter, each of the conditional expressions will be described in order.

−0.60<(1−βvc)βr<−0.32 (1)

0.60<|fr|/f<3.90 (2)

−0.3<Cr1vc/ff<9.0 (3)

wherein βvc is a magnification of the vibration control lens group Gvc, βr is a magnification of the third lens group Gr, f is a focal length of the whole optical system, fr is a focal length of the third lens group Gr, Cr1vc is a curvature radius of a surface closest to the object side in the vibration control lens group Gvc, and ff is a focal length of the first lens group Gf.

### 1-2-1. Conditional Expression (1)

The conditional expression (1) defines a ratio between the amount of movement of the vibration control lens group Gvc in the vertical direction and the amount of movement of an image point on an image plane, i.e., a blurring correction factor. In the present invention, when vibration such as camera shake occurs, the vibration control lens group Gvc is moved in a direction perpendicular to an optical axis. More specifically, during vibration control, the vibration control lens group Gvc is eccentrically positioned, so that an image, which is displaced due to vibration such as camera shake, is returned to an original image forming position. Generally, in lenses of large aperture, the generation amount of coaxial aberration tends to increase. In addition, when the vibration control lens group Gvc is eccentrically positioned, the amount of aberration generated by the eccentric positioning tends to increase. Particularly, the generation amounts of eccentric coma aberration and eccentric field curvature tend to increase. In the present invention, when the optical system is configured to satisfy the conditional expression (1), it is possible to set the blurring correction factor in a proper range, and to suppress the generation amounts of the eccentric coma aberration and the eccentric field curvature. This makes it possible to implement a lens of high brightness and large aperture which has excellent optical performance even during vibration control. As a result, excellent optical performance can be implemented even in the case where the optical system is constituted of a smaller number of lenses. This makes it possible to miniaturize the lens of large aperture.

If the value of the conditional expression (1) is equal to or below a lower limit, i.e., if the blurring correction factor decreases, the amount of movement of the vibration control lens group Gvc in the perpendicular direction during vibration control increases. Consequently, the vibration-control drive mechanisms, such as actuators for driving the vibration control lens group Gvc, are upsized. As a result, the lens-barrel for housing the optical system, the vibration-control drive mechanisms, and the like has an increased external diameter, which is not preferable for miniaturization of the lens of large aperture.

If the value of the conditional expression (1) is equal to or above an upper limit, i.e., the blurring correction factor is larger, eccentric coma aberration and eccentric field curvature fluctuate significantly during vibration control, which makes it difficult to correct these values. This may result in undesirable deterioration in the optical performance during vibration control. If the blurring correction factor is larger, the amount of movement of the vibration control lens group Gvc during vibration control decreases, and precise drive control of the vibration control lens group Gvc is required. Accordingly, loads of electrical and mechanical precision are undesirably increased.

To obtain the above effect, the optical system preferably satisfies a following conditional expression (1)′, and more preferably satisfies a following conditional expression (1)″.

−0.60<(1−βvc)βr<−0.40 (1)′

0.56<(1−βvc)βr<−0.40 (1)″

### 1-2-2. Conditional Expression (2)

The conditional expression (2) defines a ratio between a focal length of the third lens group Gr and a focal length of the whole optical system. By satisfying the conditional expression (2), excellent optical performance can be secured with a small number of lenses, and the lens of large aperture can be miniaturized, so that cost increase can be suppressed.

If the value of the conditional expression (2) is equal to or below a lower limit, the focal length of the third lens group Gr becomes too small, so that large spherical aberration and curvature of field are generated in the third lens group Gr. For correcting these aberrations and securing excellent optical performance, the number of lenses needs to be increased. This undesirably results in upsizing and cost increase of the lens of large aperture.

If the value of the conditional expression (2) is equal to or above an upper limit, the focal length of the third lens group Gr becomes too large. Accordingly, to implement the lens of large aperture with excellent optical performance, an aberration correction amount to be allocated to the first lens group Gf and/or to the vibration control lens group Gvc increases. This deteriorates the optical performance when vibration control is performed, and makes it difficult to use the lens of large aperture for the optical system.

To obtain the above effect, it is preferable that the optical system satisfies a following conditional expression (2)′. It is more preferable to satisfy a following conditional expression (2)″, and is still more preferable to satisfy a following conditional expression (2)′″.

0.62<|fr|/f<3.90 (2)′

0.62<|fr|/f<3.50 (2)″

0.65<|fr|/f<3.50 (2)″′

### 1-2-3. Conditional Expression (3)

The conditional expression (3) defines a ratio between a curvature radius of an object-side surface (optical surface) of the vibration control lens group Gvc and a focal length of the first lens group Gf. When the optical system is configured to satisfy the conditional expression (3), an axial light flux is incident on the object-side surface of the vibration control lens group Gvc from the first lens group Gf side at an angle of zero or approximately zero degree. When the axial light flux is made incident on the object-side surface of the vibration control lens group Gvc at a low angle in this way, the axial light flux is incident almost perpendicularly on the object-side surface. Accordingly, eccentric coma aberration to be generated can be decreased, and degradation of the optical performance during vibration control can be suppressed.

To obtain the above effect, the optical system preferably satisfies a following conditional expression (3)′, and more preferably satisfies a following conditional expression (3)″.

−0.1<Cr1vc/ff<8.8 (3)′

0<Cr1vc/ff<8.6 (3)″

### 1-2-4. Conditional Expression (4)

In the optical system according to the present invention, the vibration control lens group Gvc preferably satisfies a following conditional expression (4) in addition to the above-stated conditional expressions (1) to (3).

−10.0<fvc/f<−0.1 (4)

wherein fvc is a focal length of the vibration control lens group Gvc.

The above-stated conditional expression (4) defines a ratio between a focal length of the vibration control lens group Gvc and a focal length of the whole optical system. By allowing the vibration control lens group Gvc to satisfy the conditional expression (4), more excellent optical performance can be secured even during vibration control with a small number of lenses, and the lens of large aperture can be miniaturized, so that cost increase can be suppressed.

If the value of the conditional expression (4) is equal to or below a lower limit, the focal length of the vibration control lens group Gvc is too small, so that eccentric coma aberration and eccentric field curvature caused by eccentricity of the vibration control lens group Gvc during vibration control fluctuate greatly. This makes it difficult to secure satisfactory optical performance during vibration control with a small number of lenses.

If the value of the conditional expression (4) is equal to or above an upper limit, the focal length of the vibration control lens group Gvc is too large, so that the amount of movement of the vibration control lens group Gvc in the vertical direction during vibration control increases beyond a proper range. Consequently, as in the case of the conditional expression (1), vibration-control drive mechanisms are upsized and the external diameter of the lens-barrel is increased, which is not preferable for miniaturization of the lens of large aperture.

In order to obtain the above-stated effect, it is preferable for the vibration control lens group Gvc to satisfy a following conditional Expression (4)′, more preferable to satisfy a following conditional Expression (4)″, still more preferable to satisfy a following conditional Expression (4)′″, and most preferable to satisfy a following conditional Expression (4)″″.

−9<fvc/f<−0.2 (4)′

8<fvc/f<−0.3 (4)″

4.4<fvc/f<−0.6 (4)″′

4.4<fvc/f<−0.7 (4)″″

### 1-2-5. Conditional Expression (5)

In the optical system according to the present invention, the first lens group Gf preferably satisfies a following conditional expression (5) in addition to the above-stated conditional expressions (1) to (3).

0.50<|ff/f| (5)

The conditional expression (5) defines a ratio between a focal length of the first lens group Gf and a focal length of the whole optical system. By satisfying the conditional expression (5), it becomes possible to prevent the first lens group Gf from having an excessively strong refractive power and to constitute the optical system with a small number of lenses. As a result, the optical system can be miniaturized and an optical system with high optical performance can be obtained.

In order to obtain the above-stated effect, it is more preferable for the vibration control lens group Gf in the optical system to satisfy a following conditional expression (5)′, still more preferable to satisfy a following conditional expression (5)″, and yet more preferable to satisfy a following conditional expression (5)′″.

0.73<|ff/f| (5)′

0.77<|ff/f| (5)″

1.11<|ff/f| (5)″′

### 1-2-6. Conditional Expression (6)

In the optical system according to the present invention, it is effective for at least one negative lens included in the third lens group Gr to satisfy a following conditional expression (6) for correction of chromatic aberration. It is more preferable to satisfy a conditional expression (6)′, still more preferable to satisfy a conditional expression (6)″, yet more preferable to satisfy a conditional expression (6)′″, and most preferable to satisfy a conditional expression (6)″″.

71>νdn (6)

64>νdn (6)′

57>νdn (6)″

51>νdn (6)″′

41>νdn (6)″″

### 1-2-7. Conditional Expression (7)

In the optical system according to the present invention, it is effective for at least one negative lens included in the third lens group Gr to satisfy a following conditional expression (7) for correction of image plane performance. It is more preferable to satisfy a conditional expression (7)′, and still more preferable to satisfy a conditional expression (7)″.

1.48<Ndn (7)

1.51<Ndn (7)′

1.61<Ndn (7)″

### 1-3. Brightness

The present invention is preferably applied to a lens of high brightness and large aperture wherein the F-number of the whole optical system is greater than 2.8. As described in the foregoing, the vibration control lens group Gvc is placed between the first lens group Gf and the third lens group Gr, at least one negative lens is placed in the third lens group, and at least the conditional expressions (1) to (3) are satisfied. As a result, parameters such as the moving amount of the vibration control lens group Gvc during vibration control, the blurring correction factor, the refractive power of each of the lens groups, and the paraxial magnification can be optimized. This makes it possible to implement a lens of large aperture having excellent optical performance even during vibration control.

In order to more reliably secure the effects of the present invention, the present invention is more preferably applied to the optical system wherein the F-number of the whole optical system is greater than 2.4, still more preferably applied to the optical system wherein the F-number is greater than 2.0, and yet much more preferably applied to the optical system wherein the F-number is greater than 1.8. According to the present invention, in the lens of large aperture having the F-number being greater than 2.8, it becomes possible to achieve miniaturization and weight reduction of a vibration control mechanism which includes the vibration control lens group Gvc and the vibration-control drive mechanisms. As a result, a lens of high brightness and large aperture having excellent optical performance during vibration control may be obtained with a small number of lenses.

### 2. Imaging Device

A description is now given of an imaging device according to the present invention. The imaging device according to the present invention includes an optical system according to the present invention, and an image sensor provided on an image side of the optical system for converting an optical image formed by the optical system into an electrical signal. The image sensor and the like are not particularly limited, and solid-state image sensors, such as CCD sensors and CMOS sensors, may be used. The imaging device according to the present invention is suitable as an imaging device such as digital cameras and video cameras which include these solid-state image sensors. It is naturally understood that the imaging device may be of a lens-fixed type wherein lenses are fixed to a casing, and may be of an interchangeable lens type, such as single-lens reflex cameras and mirrorless single lens cameras.

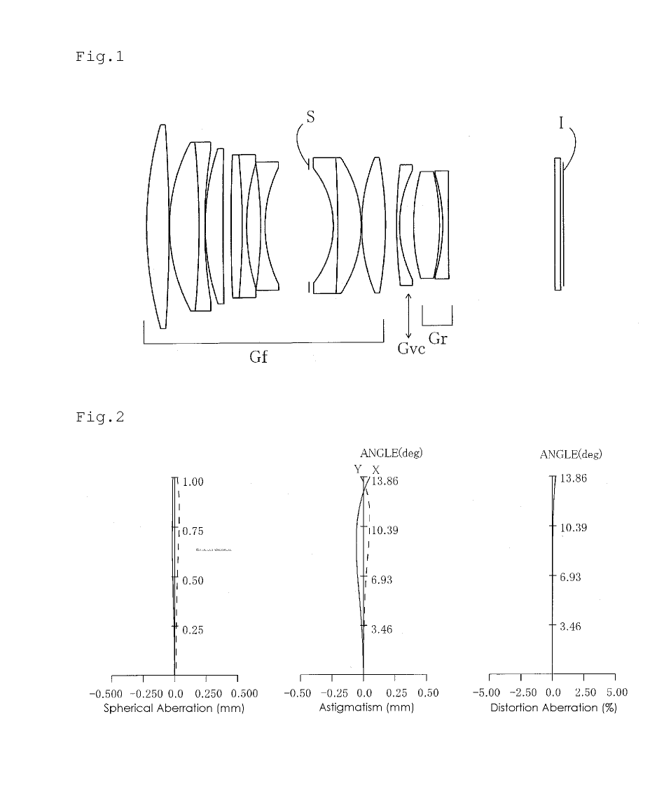

Now, the present invention will specifically be described by using Examples and Comparative Examples. However, the present invention is not limited to the following Examples. The optical system in each of the following Examples is a photographing optical system used for an imaging device (optical device), such as digital cameras, video cameras, and silver-salt film cameras. In the cross sectional views of lenses (FIGS. 1, 4, 7, 10, and 13), the left-hand side of the page is an object side, and the right-hand side is an image side.

### Example 1

### (1) Configuration of Optical System

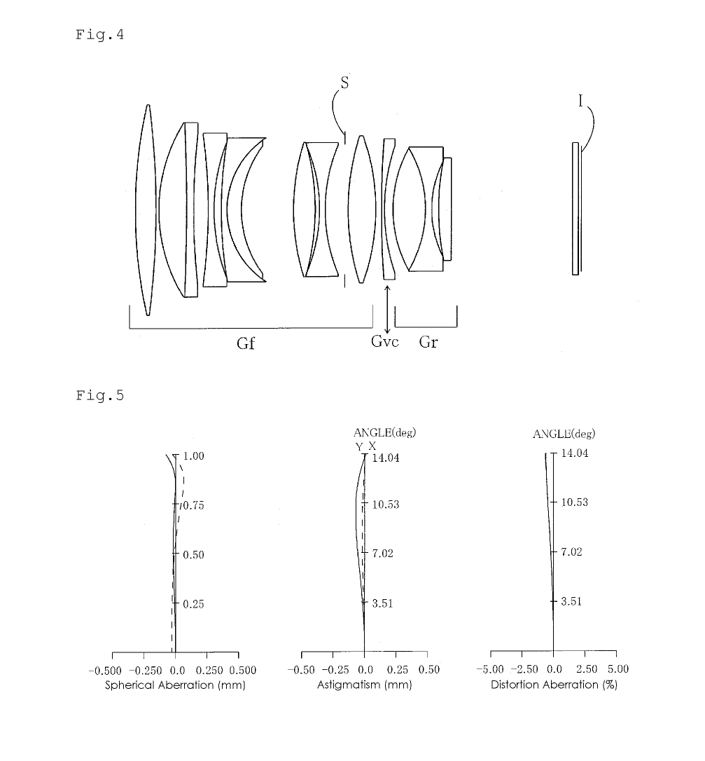

FIG. 1 is a cross sectional view of lenses for illustrating the configuration of a fixed-focus lens constituting an optical system of Example 1 according to the present invention. The fixed-focus lens includes: a first lens group Gf having positive refractive power; a vibration control lens group Gvc having negative refractive power; and a third lens group Gr having positive refractive power, provided in order from the object side. These lens groups constitute the fixed-focus lens. The vibration control lens group changes an image position by moving in a direction perpendicular to an optical axis. The vibration control lens group Gvc can reduce image blurring attributed to vibration such as camera shake during imaging. In FIG. 1, a reference character “S” illustrated in the first lens group Gf denotes an aperture stop. A reference character “I” illustrated on the image side of the third lens group Gr denotes an image plane. Specifically, it denotes an imaging plane of a solid-state image sensor, such as CCD sensors and CMOS sensors, or a film plane of a silver-salt film. The specific lens configuration of each lens group is as illustrated in FIG. 1. Since these reference characters designate identical component members in FIGS. 4, 7, 10, and 13 illustrated in Examples 2 to 5, the description thereof will be omitted in the following description.

### (2) Typical Numerical Value

A description is now given of a typical numerical value to which specific values of the fixed-focus lens is applied. Table 1 illustrates lens data on the fixed-focus lens. In Table 1, No. represents surface number of a lens surface counted from the object side, R represents a curvature radius of the lens surface, D represents a distance between the lens surfaces on the optical axis, Nd represents a refractive index with respect to the d-line (wavelength λ=587.6 nm), νd represents an Abbe number with respect to the d-line (wavelength λ=587.6 nm). The aperture stop (aperture S) is expressed by “STOP” put in No. column. When a lens surface is aspherical, the lens is expressed by “ASPH” put in No. column, and its paraxial curvature radius is put in a column of the curvature radius R. Since these rules are similarly applied to Tables 2, 3, 5, and 7 illustrated in Examples 2 to 5, a description thereof will be omitted in the following description.

FIG. 2 illustrates longitudinal aberration diagrams when the fixed-focus lens focuses at infinity. The longitudinal aberration diagrams illustrates a spherical aberration, an astigmatism, and a distortion aberration in order from the left-hand side on the page. In the diagram illustrating the spherical aberration, a solid-line represents a d-line (587.6 nm) and a broken line represents a g-line (435.8 nm). In the diagram illustrating the astigmatism, a solid-line represents a sagittal direction X of the d-line, and a broken line represents a meridional direction Y of the d-line. Since the order of illustration of these aberrations and what the solid-lines and the broken lines represent in the respective diagrams are also the same in FIGS. 5, 8, 11, and 14 illustrated in Examples 2 to 5, a description thereof will be omitted in the following description.

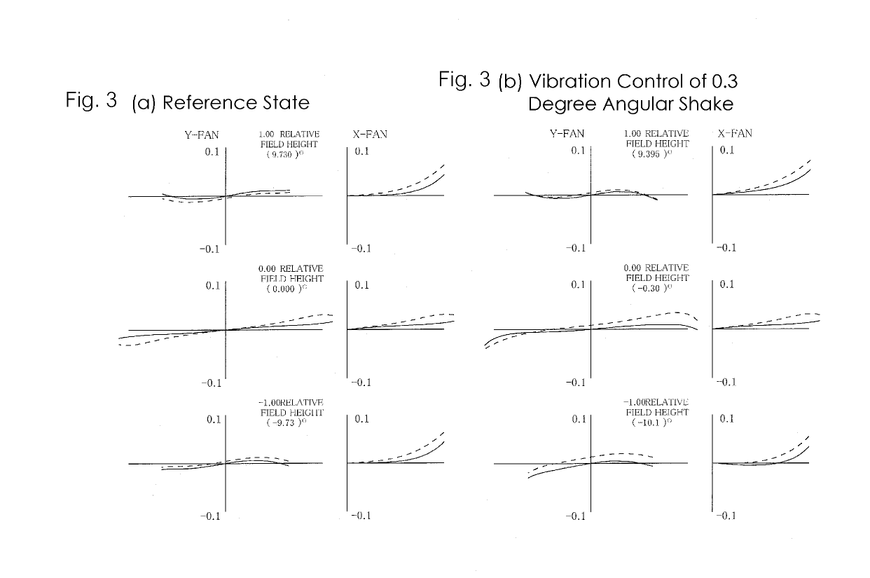

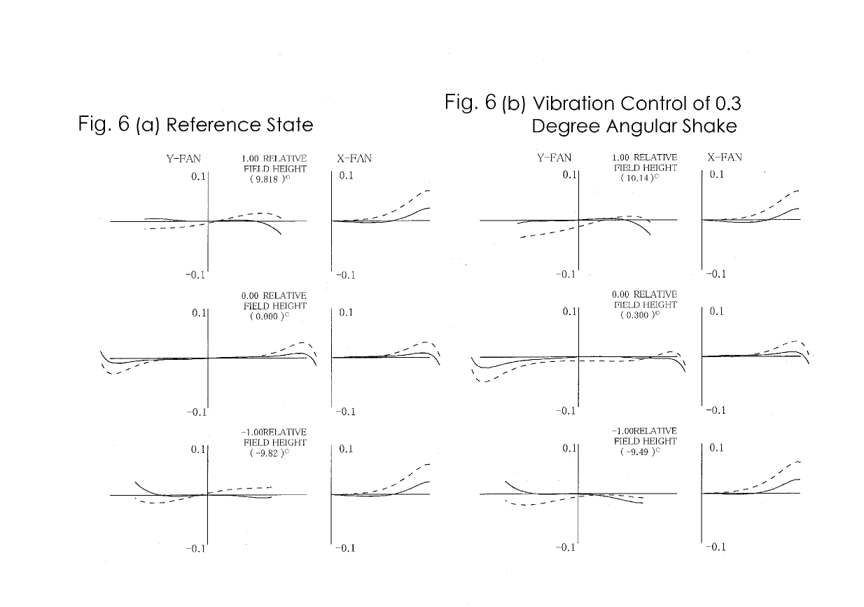

FIG. 3A illustrates lateral aberration diagrams in a reference state when focusing at infinity, and FIG. 3B illustrates lateral aberration diagrams at the time of correcting an angular shake of 0.3 degrees when focusing at infinity. Lateral aberration on the axis is illustrated at the center, while lateral aberration at 70 percent image height is illustrated on the upper and lower sides. A solid-line represents a d-line (587.6 nm) and a broken line represents a g-line (435.8 nm). Since the order of illustration of these aberrations and what the solid and the broken lines represent in the respective diagrams are also the same in FIGS. 6, 9, 12, and 15 illustrated in Examples 2 to 5, a description thereof will be omitted in the following description.

A focal length (f) of the fixed-focus lens, a large aperture ratio (F-number), and a view angle (ω) are each as described below. The values in each of the conditional expressions (1) to (7) are illustrated in Table 9.

f=87.5187, F-number=1.4578, ω=13.8585 degrees

TABLE 1

| No. | R | D | Nd | νd |
|---|---|---|---|---|
| 1 | 130.5915 | 7.7913 | 1.8348 | 42.72 |
| 2 | −511.5873 | 0.2000 | | |
| 3 | 61.9450 | 10.2311 | 1.4370 | 95.10 |
| 4 | −315.6108 | 2.0000 | 1.8467 | 23.78 |
| 5 | 163.4058 | 0.2000 | | |
| 6 | 84.8549 | 6.1756 | 1.4370 | 95.10 |
| 7 | 1244.5105 | 2.7767 | | |
| 8 | 630.0948 | 3.9085 | 1.8467 | 23.78 |
| 9 | −260.1856 | 1.5000 | 1.5163 | 64.14 |
| 10 | 73.9656 | 4.9026 | | |
| 11 | −143.7768 | 1.5000 | 1.4875 | 70.24 |
| 12 | 45.4403 | 15.2727 | | |
| STOP | 0 | 8.5154 | | |
| 14 | −32.0994 | 1.5000 | 1.6727 | 32.10 |
| 15 | −455.7313 | 8.1563 | 1.8348 | 42.72 |
| 16 | −42.8293 | 0.2000 | | |
| 17 | 63.2271 | 8.2536 | 1.6968 | 55.46 |
| 18 | −131.6830 | 3.9161 | | |
| 19 | 175.2441 | 1.0000 | 1.4875 | 70.24 |
| 20 | 42.0498 | 4.8927 | | |
| 21 | 73.1809 | 8.9962 | 1.8040 | 46.58 |
| 22 | −84.1420 | 1.1111 | | |
| 23 | −59.9352 | 2.0000 | 1.8052 | 25.46 |
| 24 | 3171.6936 | 2.0000 | | |
| 25 | 0 | 34.9999 | | |
| 26 | 0 | 2.0000 | 1.5168 | 64.20 |
| 27 | 0 | 1.0588 | | |
| 28 | 0 | −0.0587 | | |

### Example 2

### (1) Configuration of Optical System

FIG. 4 is a cross sectional view of lenses for illustrating the configuration of a fixed-focus lens constituting an optical system of Example 2 according to the present invention. The fixed-focus lens includes: a first lens group Gf having positive refractive power; a vibration control lens group Gvc having negative refractive power; and a third lens group Gr having positive refractive power, provided in order from the object side. These lens groups constitute the fixed-focus lens. The function of the vibration control lens group Gvc is the same as that of Example 1. The specific lens configuration is as illustrated in FIG. 4.

### (2) Typical Numerical Value

A description is now given of a typical numerical value to which specific values of the fixed-focus lens is applied. Table 2 illustrates lens data on the fixed-focus lens. FIG. 5 illustrates longitudinal aberration diagrams when focusing at infinity. FIG. 6A illustrates lateral aberration diagrams in a reference state when focusing at infinity, and FIG. 3B illustrates lateral aberration diagrams at the time of correcting an angular shake of 0.3 degrees when focusing at infinity.

A focal length (f) of the fixed-focus lens, a large aperture ratio (F-number), and a view angle (ω) are each as described below. The values in each of the conditional expressions (1) to (7) are illustrated in Table 9.

F=87.0859, F-number=1.4743, ω=14.0419 degrees

TABLE 2

| No. | R | D | Nd | νd |
|---|---|---|---|---|
| 1 | 165.4816 | 7.2000 | 1.7292 | 54.67 |
| 2 | −281.6076 | 1.0000 | | |
| 3 | 57.1839 | 9.6000 | 1.4970 | 81.61 |
| 4 | −732.6318 | 2.4873 | 1.8467 | 23.78 |
| 5 | 241.3524 | 5.0428 | | |
| 6 | −189.8873 | 2.0000 | 1.4875 | 70.24 |
| 7 | 63.9570 | 2.5421 | | |
| 8 | 142.2633 | 2.0000 | 1.4875 | 70.44 |
| 9 | 29.5854 | 5.0000 | 1.9037 | 31.31 |
| 10 | 36.6588 | 18.1275 | | |
| 11 | 77.7797 | 7.5000 | 1.5928 | 68.62 |
| 12 | −84.1315 | 1.4990 | | |
| 13 | −56.3694 | 2.0000 | 1.6990 | 30.05 |
| 14 | 57.3014 | 6.8420 | | |
| STOP | 0 | 1.1233 | | |
| 16 | 83.1141 | 9.6000 | 1.9108 | 35.25 |
| 17 | −75.2992 | 2.0000 | | |
| 18 | 338.7740 | 1.0000 | 1.4875 | 70.44 |
| 19 | 67.4539 | 3.0000 | | |
| 20 | 43.3795 | 11.2500 | 1.5928 | 68.62 |
| 21 | −41.5126 | 2.2000 | 1.6200 | 36.30 |
| 22 | 36.4486 | 2.3665 | | |
| 23 | 86.0703 | 4.4500 | 1.9108 | 35.25 |
| 24 | −5000.0000 | 2.5343 | | |
| 25 | 0 | 39.6000 | | |
| 26 | 0 | 2.0000 | 1.5168 | 64.20 |
| 27 | 0 | 1.0347 | | |
| 28 | 0 | −0.0347 | | |

### Example 3

### (1) Configuration of Optical System

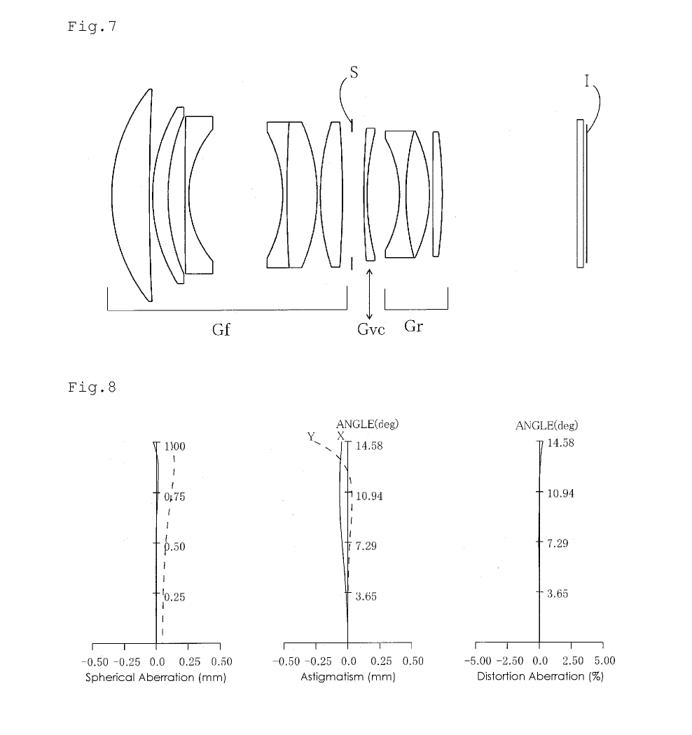

FIG. 7 is a cross sectional view of lenses for illustrating the configuration of a fixed-focus lens constituting an optical system of Example 3 according to the present invention. The fixed-focus lens includes: a first lens group Gf having positive refractive power; a vibration control lens group Gvc having negative refractive power; and a third lens group Gr having positive refractive power, provided in order from the object side. These lens groups constitute the fixed-focus lens. The function of the vibration control lens group Gvc is the same as that of Example 1. The specific lens configuration is as illustrated in FIG. 7.

### (2) Typical Numerical Value

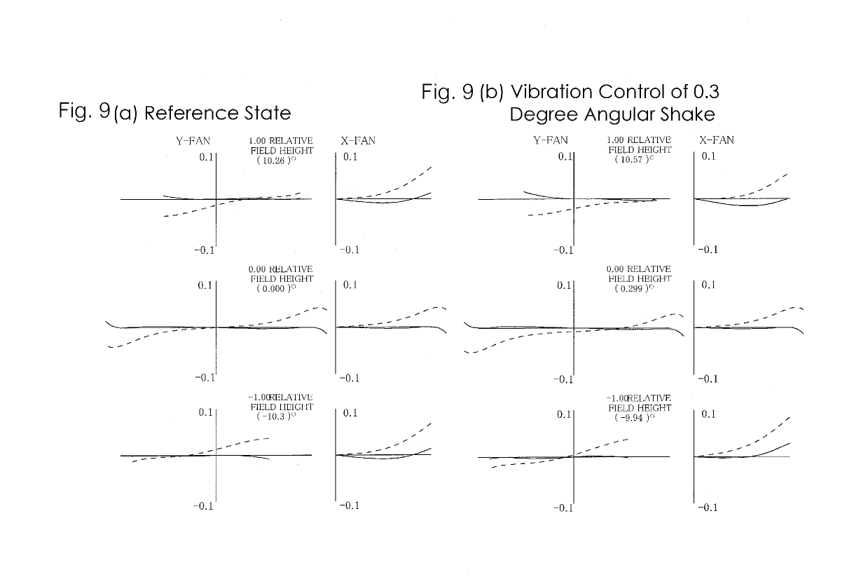

A description is now given of a typical numerical value to which specific values of the fixed-focus lens is applied. Table 3 illustrates lens data on the fixed-focus lens. FIG. 8 illustrates longitudinal aberration diagrams when focusing at infinity. FIG. 9A illustrates lateral aberration diagrams in a reference state when focusing at infinity, and FIG. 9B illustrates lateral aberration diagrams at the time of correcting an angular shake of 0.3 degrees when focusing at infinity.

A focal length (f) of the fixed-focus lens, a large aperture ratio (F-number), and a view angle (ω) are each as described below. The values in each of the conditional expressions (1) to (7) are illustrated in Table 9.

F=82.8700, F-number=1.4617, ω=14.5834 degrees

TABLE 3

| No. | R | D | Nd | νd |
|---|---|---|---|---|
| 1 | 52.5487 | 11.7380 | 1.7469 | 49.22 |
| 2 | 684.1766 | 1.0000 | | |
| 3 | 52.0526 | 4.8000 | 1.8565 | 32.27 |
| 4 | 63.0459 | 5.2500 | | |
| 5 | 1282.1057 | 1.2003 | 1.6777 | 32.10 |
| 6 | 31.6602 | 29.3008 | | |
| 7 | −42.2805 | 1.3000 | 1.7617 | 27.53 |
| 8 | 358.0772 | 9.4000 | 1.8395 | 42.72 |
| 9 | −55.9281 | 1.0000 | | |
| 10 | 74.0045 | 6.9000 | 1.8395 | 42.72 |
| 11 | −314.6059 | 2.9808 | | |
| STOP | 0 | 3.7071 | | |
| 13 | 264.1298 | 1.0000 | 1.6998 | 55.46 |
| 14 | 77.3091 | 10.0815 | | |
| 15 | −36.3902 | 2.0000 | 1.7471 | 27.79 |
| 16 | 77.5544 | 7.3411 | 1.9170 | 35.25 |
| 17 | −45.4256 | 1.0004 | | |
| ASPH | 639.9402 | 3.0000 | 1.8877 | 37.22 |
| 19 | −158.3350 | 41.9994 | | |
| 20 | 0 | 2.0000 | 1.5187 | 64.20 |
| 21 | 0 | 1.0000 | | |
| 22 | 0 | 0.0151 | | |

Table 4 illustrates aspheric factors and a conic constant when the aspherical surface illustrated in Table 3 is expressed by a following expression. The aspheric factors and conic constants in later-described Tables 6 and 8 are similarly based on the following definitions.

The aspherical surface is herein defined by the following expression:

z=ch2/[1+{1−(1+k)c2h2}½]+A4h4+A6h6+A8h8+A10h10

(wherein c represents a curvature (1/r), h represents a height from an optical axis, k represents a conic constant, and A4, A6, A8, A10 . . . represent aspheric factors of respective orders)

TABLE 4

| No. | K | A4 | A6 | A8 | A10 |
|---|---|---|---|---|---|
| 18 | 0.0000E+00 | −1.2422E−06 | −2.4860E−10 | −4.0303E−13 | −3.3628E−16 |

### Example 4

### (1) Configuration of Optical System

FIG. 10 is a cross sectional view of lenses for illustrating the configuration of a fixed-focus lens constituting an optical system of Example 4 according to the present invention. The fixed-focus lens includes: a first lens group Gf having negative refractive power; a vibration control lens group Gvc having negative refractive power; and a third lens group Gr having positive refractive power, provided in order from the object side. These lens groups constitute the fixed-focus lens. The function of the vibration control lens group Gvc is the same as that of Example 1. The specific lens configuration is as illustrated in FIG. 10.

### (2) Typical Numerical Value

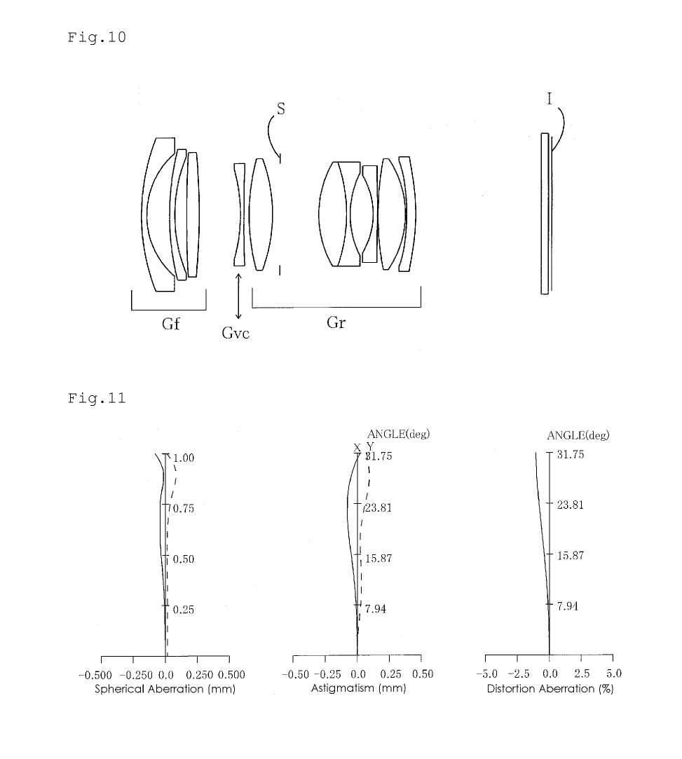

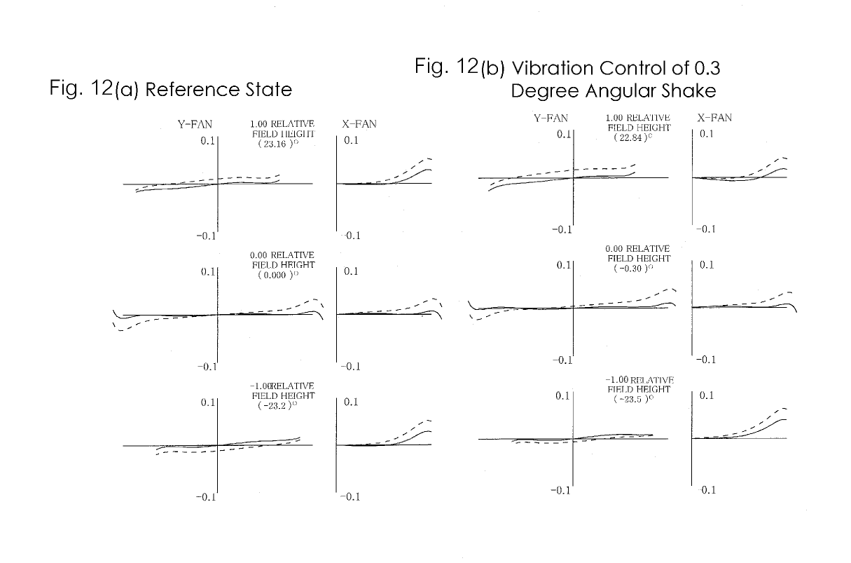

A description is now given of a typical numerical value to which specific values of the fixed-focus lens is applied. Table 5 illustrates lens data on the fixed-focus lens. FIG. 11 illustrates longitudinal aberration diagrams when focusing at infinity. FIG. 12A illustrates lateral aberration diagrams in a reference state when focusing at infinity, and FIG. 12B illustrates lateral aberration diagrams at the time of correcting an angular shake of 0.3 degrees when focusing at infinity.

A focal length (f) of the fixed-focus lens, a large aperture ratio (F-number), and a view angle (ω) are each as described below. The values in each of the conditional expressions (1) to (7) are illustrated in Table 9.

F=35.3524, F-number=1.8354, ω=31.7460 degrees

TABLE 5

| No. | R | D | Nd | νd |
|---|---|---|---|---|
| 1 | 58.8035 | 1.5000 | 1.5168 | 64.20 |
| 2 | 23.0731 | 6.5474 | | |
| 3 | 75.0230 | 1.5000 | 1.6180 | 63.39 |
| 4 | 43.6088 | 3.3982 | | |
| 5 | 327.9197 | 3.5859 | 1.7408 | 27.76 |
| 6 | −199.2922 | 11.7995 | | |
| 7 | −48.4812 | 1.0000 | 1.5168 | 64.20 |
| 8 | 448.7897 | 1.5000 | | |
| 9 | 59.7707 | 6.7095 | 1.5928 | 68.62 |
| 10 | −45.3546 | 2.1566 | | |
| STOP | 0 | 11.0735 | | |
| 12 | 29.1436 | 7.9767 | 1.8348 | 42.72 |
| 13 | −44.4621 | 1.0056 | 1.6889 | 31.16 |
| 14 | 25.9492 | 6.5903 | | |
| 15 | −21.8007 | 1.2000 | 1.7174 | 29.50 |
| 16 | −816.7136 | 0.2014 | | |
| 17 | 80.8248 | 7.8510 | 1.8042 | 46.50 |
| 18 | −27.9048 | 0.3148 | | |
| ASPH | −77.7618 | 2.6143 | 1.8014 | 45.45 |
| ASPH | −62.4139 | 35.9755 | | |
| 21 | 0 | 2.0000 | 1.5168 | 64.20 |
| 22 | 0 | 1.0413 | | |
| 23 | 0 | −0.0413 | | |

Table 6 illustrates aspheric factors and a conic constant of the aspherical surfaces illustrated in Table 5.

TABLE 6

| No. | K | A4 | A6 | A8 | A10 | A12 |
|---|---|---|---|---|---|---|
| 19 | 0.0000E+00 | −1.2866E−05 | 4.6104E−09 | −1.9619E−11 | 1.7757E−13 | 9.4853E−16 |
| 20 | 0.0000E+00 | 2.7066E−07 | 1.0370E−08 | 7.2545E−11 | −1.7881E−13 | 7.0915E−17 |

### Example 5

### (1) Configuration of Optical System

FIG. 13 is a cross sectional view of lenses for illustrating the configuration of a fixed-focus lens constituting an optical system of Example 5 according to the present invention. The fixed-focus lens includes: a first lens group Gf having negative refractive power; a vibration control lens group Gvc having negative refractive power; and a third lens group Gr having positive refractive power, provided in order from the object side. These lens groups constitute the fixed-focus lens. The function of the vibration control lens group Gvc is the same as that of Example 1. The specific lens configuration is as illustrated in FIG. 13.

### (2) Typical Numerical Value

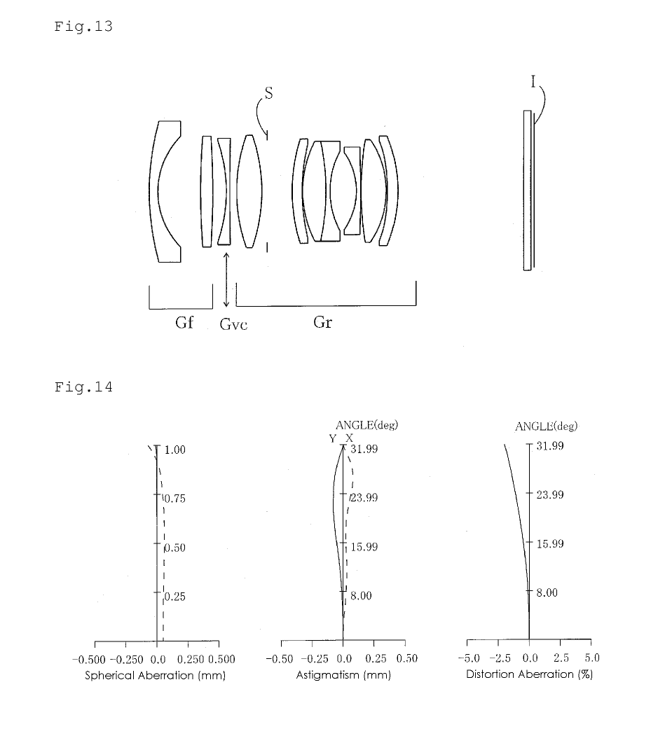

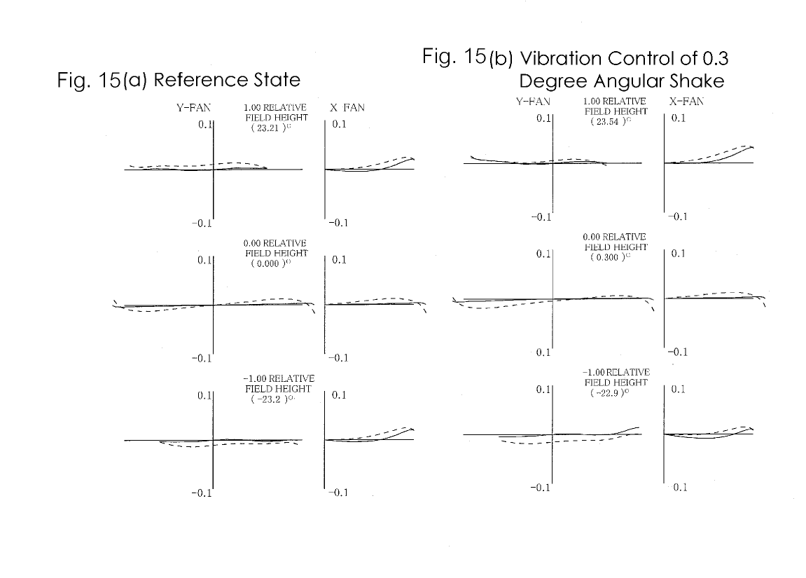

A description is now given of a typical numerical value to which specific values of the fixed-focus lens is applied. Table 7 illustrates lens data on the fixed-focus lens. FIG. 14 illustrates longitudinal aberration diagrams when focusing at infinity. FIG. 15A illustrates lateral aberration diagrams in a reference state when focusing at infinity, and FIG. 15B illustrates lateral aberration diagrams at the time of correcting an angular shake of 0.3 degrees when focusing at infinity.

A focal length (f) of the fixed-focus lens, a large aperture ratio (F-number), and a view angle (ω) are each as described below. The values in each of the conditional expressions (1) to (7) are illustrated in Table 9.

F=35.3498, F-number=1.8352, ω=31.9864 degrees

TABLE 7

| No. | R | D | Nd | νd |
|---|---|---|---|---|
| ASPH | 71.8890 | 2.5000 | 1.6935 | 53.20 |
| ASPH | 22.0526 | 12.3467 | | |
| 3 | 223.4425 | 3.4553 | 1.8467 | 23.78 |
| 4 | −244.1103 | 3.9109 | | |
| 5 | −43.8869 | 1.0000 | 1.5168 | 64.20 |
| 6 | 703.0434 | 2.0002 | | |
| 7 | 48.0382 | 7.2379 | 1.5928 | 68.62 |
| 8 | −48.2641 | 1.5333 | | |
| STOP | 0 | 7.2229 | | |
| 10 | 49.4118 | 2.8634 | 1.6968 | 55.46 |
| 11 | 56.5777 | 0.1500 | | |
| 12 | 30.9592 | 6.6907 | 1.8348 | 42.72 |
| 13 | −66.8414 | 1.2000 | 1.6990 | 30.05 |
| 14 | 24.2401 | 7.5851 | | |
| 15 | −19.0972 | 1.2000 | 1.7174 | 29.50 |
| 16 | −330.8818 | 0.1500 | | |
| 17 | 91.8840 | 7.2347 | 1.7725 | 49.62 |
| 18 | −25.8572 | 0.3000 | | |
| ASPH | −65.0125 | 3.0806 | 1.8014 | 45.45 |
| ASPH | −40.8735 | 36.2516 | | |
| 21 | 0 | 2.0000 | 1.5168 | 64.20 |
| 22 | 0 | 1.0116 | | |
| 23 | 0 | −0.0115 | | |

Table 8 illustrates aspheric factors and a conic constant of the aspherical surfaces illustrated in Table 7.

TABLE 8

| No. | K | A4 | A6 | A8 | A10 | A12 |
|---|---|---|---|---|---|---|
| 1 | −2.8777E−01 | −1.9212E−07 | −9.3030E−10 | 2.5195E−12 | 2.2543E−15 | −1.7506E−17 |
| 2 | −6.0999E−02 | −1.1417E−06 | 4.9762E−09 | −8.4047E−11 | 4.4284E−13 | −8.2534E−16 |
| 19 | 0.0000E+00 | −1.6083E−05 | −3.1784E−08 | 2.3495E−10 | −7.0783E−13 | 7.5796E−16 |
| 20 | 0.0000E+00 | −2.8710E−06 | −2.4337E−08 | 2.6187E−10 | −7.1100E−13 | 8.3518E−16 |

The values of the conditional expressions in each of the typical numerical values are illustrated in Table 9.

TABLE 9

| | Example 1 | Example 2 | Example 3 | Example 4 | Example 5 |
|---|---|---|---|---|---|
| Conditional expression (1) | 0.447 | 0.351 | 0.323 | 0.560 | 0.588 |
| Conditional expression (2) | 1.547 | 1.513 | 1.062 | 0.996 | 1.004 |
| Conditional expression (3) | 2.144 | 3.450 | 2.871 | 0.624 | 0.534 |
| Conditional expression (4) | −1.300 | −1.986 | −1.889 | −2.393 | −2.260 |
| Conditional expression (5) | 0.934 | 1.128 | 1.110 | 2.198 | 2.323 |
| Conditional expression (6) | 25.460 | 36.300 | 27.790 | 31.160 | 30.050 |
| Conditional expression (7) | 1.805 | 1.620 | 1.747 | 1.689 | 1.699 |

### INDUSTRIAL APPLICABILITY

According to the present invention, it becomes possible to achieve miniaturization and weight reduction of a vibration control optical system, and to provide an optical system having excellent optical performance even during vibration control, high brightness and a large aperture.

### REFERENCE SIGNS LIST

Gf First lens group
Gr Third lens group
Gvc Vibration control lens group
S Stop
I Image surface

1. An optical system, comprising:
a first lens group Gf;
a vibration control lens group Gvc for changing an image position by moving in a direction vertical to an optical axis; and
a third lens group Gr, the first lens group Gf, the vibration control lens group Gvc, and the third lens group Gr being provided in order from an object side, wherein
the third lens group Gr has at least one lens having negative refractive power, and
following conditional expressions (1) to (3) are satisfied:
−0.60<(1−βvc)βr<−0.32 (1)
0.60<|fr|/f<3.90 (2)
−0.3<Cr1vc/ff<9.0 (3)
wherein βvc is a magnification of the vibration control lens group Gvc,
βr is a magnification of the third lens group Gr,
f is a focal length of the whole optical system,
fr is a focal length of the third lens group Gr,
Cr1vc is a curvature radius of a surface closest to the object side in the vibration control lens group Gvc, and
ff is a focal length of the first lens group Gf.

2. The optical system according to claim 1, wherein F-number of the whole system is greater than 2.8.

3. The optical system according to claim 1, wherein the third lens group Gr has positive refractive power.

4. The optical system according to claim 1, wherein the vibration control group Gvc satisfies a following conditional expression (4):
−10.0<fvc/f<−0.1 (4)
wherein fvc is a focal length of the vibration control lens group Gvc.

5. The optical system according to claim 1, wherein the first lens group Gf satisfies a following conditional expression (5):
0.50<|ff/f| (5)

6. An imaging device, comprising:
an optical system according to claim 1; and
an image sensor provided on an image side of the optical system for converting an optical image formed by the optical system into an electrical signal.
